(19) United States
(12) Patent Application Publication
(10) Pub. No.: US 2025/0149936 A1
(43) Pub. Date: May 8, 2025

(54) STATOR

(71) Applicant: TOYOTA JIDOSHA KABUSHIKI KAISHA, Toyota-shi (JP)

(72) Inventor: Hideaki Miyazono, Kasugai-shi (JP)

(73) Assignee: TOYOTA JIDOSHA KABUSHIKI KAISHA, Toyota-shi (JP)

(21) Appl. No.: 18/777,803

(22) Filed: Jul. 19, 2024

(30) Foreign Application Priority Data
Nov. 7, 2023 (JP) 2023-190016

(51) Int. Cl. H02K 1/20

(52) U.S. Cl. CPC H02K 1/20

(57) ABSTRACT

A stator includes a stator core having a slot extending in an axial direction, at least one first segment coil that extends the slot of the stator core in a first direction, at least one second segment coil that extends the slot of the stator core in a second direction, at least one connecting member that connects at least one tip end of the first segment coil to at least one tip end of the second segment coil in the slot of the stator core, a refrigerant flow passage that passes through the stator core, and the refrigerant flow passage is connected to a section of the slot in which at least one connecting member is positioned.

### CROSS-REFERENCE TO RELATED APPLICATION

This application claims priority to Japanese Patent Application No. 2023-190016 filed on Nov. 7, 2023, incorporated herein by reference in its entirety.

### BACKGROUND

### 1. Technical Field

A technique disclosed in the present specification relates to a stator.

### 2. Description of Related Art

A stator in a motor may be configured by, for example, inserting a stator coil into a slot of a stator core. As such a stator coil, a stator coil is known in which segment coils divided into a plurality of segments in an axial direction of a stator and a connecting member that connects the segment coils to each other constitute the stator coil (Japanese Unexamined Patent Application Publication No. 2019-126153 (JP 2019-126153 A)).

### SUMMARY

In such segment coils, there have been cases where thermal resistance at a connection portion between the segment coil and the connecting member may increase. It is desirable to suppress heating of the connection portion in the slot of the stator core.

The present specification provides a technique for effectively cooling a connection portion of a plurality of segment coils connected in a slot of a stator core.

The technique disclosed in the present specification is embodied in a stator. A stator includes: a stator core including a slot extending in an axial direction; at least one first segment coil extending in the slot of the stator core in a first direction; at least one second segment coil extending in the slot of the stator core in a second direction; at least one connecting member that connects a tip end of the at least one first segment coil to a tip end of the at least one second segment coil in the slot of the stator core; and a refrigerant flow path that passes through an inside of the stator core. The refrigerant flow path is connected to a part of a section of the slot, the section being a section in which the at least one connecting member is positioned.

In the slot of the stator core, a connection portion between the segment coil and the connecting member may be heated due to an increase in thermal resistance. With the stator of the present disclosure, the connection portion can be cooled by being supplied with a refrigerant, in a part of the section in which the connecting member in the slot is positioned.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view of a part of a stator of a first embodiment at one end (A end);

FIG. 2 is a cross-sectional view of a line II′-II″ in FIG. 1 showing a cross-sectional structure of a stator core of a first embodiment and an enlarged cross-sectional view of a housed coil;

FIG. 3A is a cross-sectional view taken along line IIIA-IIIA of FIG. 2;

FIG. 3B is a cross-sectional view taken along line IIIB-IIIB of FIG. 2;

FIG. 4 is a cross-sectional view taken along the line II-II in FIG. 1 showing a cross-sectional structure of a stator core of a second embodiment;

FIG. 5 is a cross-sectional view taken along the line II-II in FIG. 1 showing a cross-sectional structure of a stator core according to a third embodiment;

FIG. 6A is a view showing an A-A line cross section of FIG. 5;

FIG. 6B is a view showing a B-B line cross section of FIG. 5; and

FIG. 6C is a view showing a C-C line cross section of FIG. 5.

### DETAILED DESCRIPTION OF EMBODIMENTS

A stator disclosed in the present specification includes a stator core having a slot extending in an axial direction, at least one first segment coil extending in a first direction in the slot of the stator core, at least one second segment coil extending in a second direction in the slot of the stator core, and at least one connecting member connecting a tip end of the at least one first segment coil to a tip end of the at least one second segment coil in the slot of the stator core, and a refrigerant flow path passing through an inside of the stator core. The refrigerant flow path may be connected to a partial section of the slot in which the at least one connecting member is positioned.

Another aspect of the stator disclosed in the present specification may be that the refrigerant flow path may include a first axial refrigerant flow path that extends from a first end of the stator core along the axial direction, a second axial refrigerant flow path that extends from a second end of the stator core along the axial direction, a first communication refrigerant flow path that extends from the first axial refrigerant flow path to the section, and a second communication refrigerant flow path that extends from the second axial refrigerant flow path to the section. In this way, the refrigerant can be easily supplied to the space and cooled.

Another aspect of the stator disclosed in the present specification may be that the refrigerant flow path may include an axial refrigerant flow path that extends from first end to the second end of the stator core along the axial direction, a first communication refrigerant flow path that extends from a first intermediate position of the axial refrigerant flow path to the section of the slot, and a second communication refrigerant flow path that extends from a second intermediate position different from the first intermediate position of the axial refrigerant flow path to the section of the slot. In this way, the refrigerant can be easily supplied to the space and cooled.

Another aspect of the stator disclosed in the present specification may be that the refrigerant flow path may include an axial refrigerant flow path that extends from first end to the second end of the stator core along the axial direction, and a communication refrigerant flow path that extends from an intermediate position of the axial refrigerant flow path to the section of the slot. In this way, the refrigerant can be easily supplied to the space and cooled.

Another aspect of the stator disclosed in the present specification is that both sides of the section in the axial direction may be filled with a filler material inside the slot. In this way, the refrigerant can be reliably and selectively supplied to the space, and the connection portion can be more efficiently cooled.

Another aspect of the stator disclosed in the present specification is that the connecting member may be disposed to be shifted in an axial direction of the stator core with respect to a connecting member of another segment coil adjacent to the stator core in a radial direction or a circumferential direction. With this configuration, the connecting members are disposed not to be adjacent to each other in the radial direction, so that the connecting members can be efficiently cooled.

Hereinafter, an embodiment of the motor of the present disclosure will be described with reference to the drawings as appropriate. In the present specification, when simply “axial direction” is used, it means the axial direction of the stator core, when simply “radial direction” is used, it means the radial direction of the stator core, and when simply “circumferential direction” is used, it means the circumferential direction of the stator core. In the drawing, the axial direction is represented by X, and the radial direction is represented by Y.

### First Embodiment

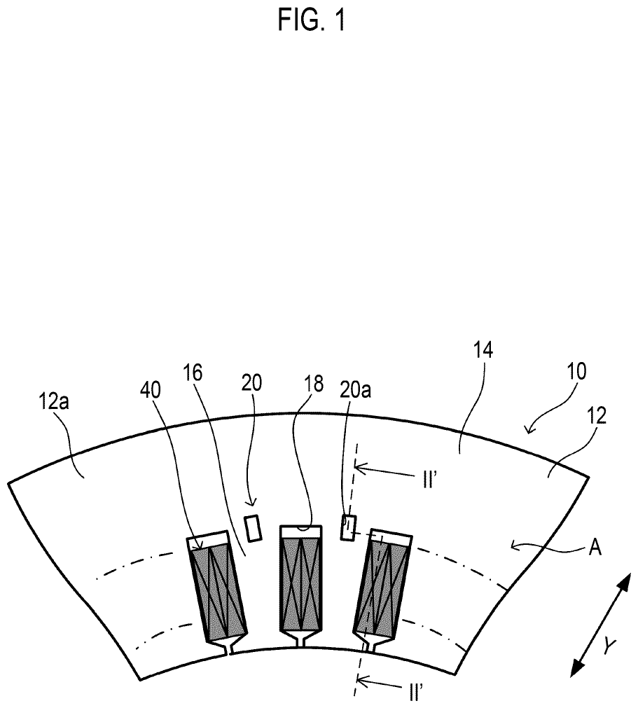

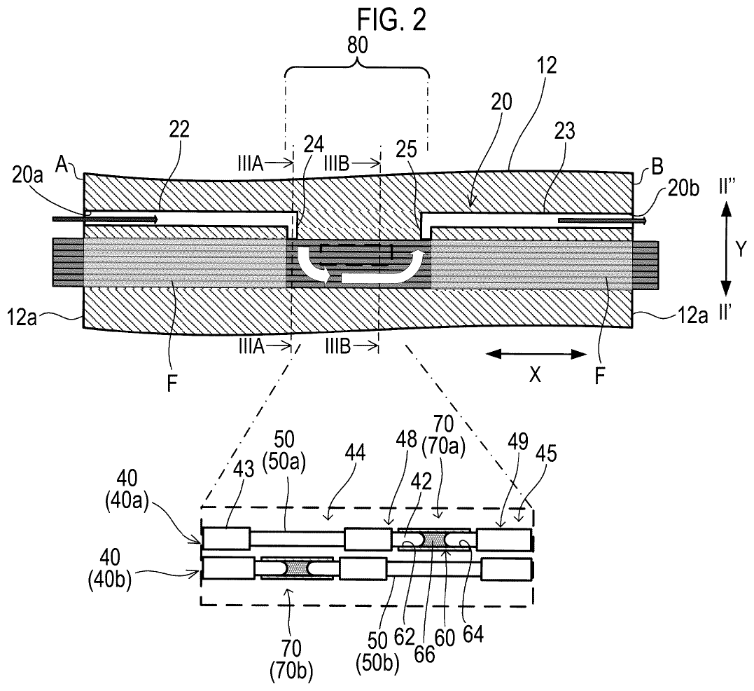

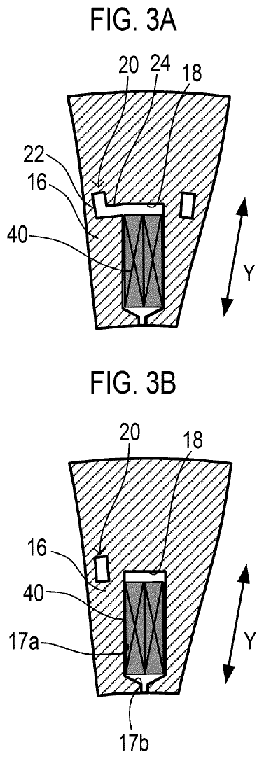

FIG. 1 and FIGS. 3A and 3B relate to a first embodiment. FIG. 1 is a plan view of a part of a stator core at an A end that is first end thereof; FIG. 2 is a cross-sectional view taken along a line II-II in FIG. 1 showing a cross-sectional structure of the stator core and an enlarged cross-sectional view of a housed coil in the stator core; FIG. 3A is a cross-sectional view taken along a line IIIA-IIIA in FIG. 2; and FIG. 3B is a cross-sectional view taken along a line IIIB-IIIB in FIG. 2.

FIG. 1 shows a part of the stator 10. The stator 10 in the present embodiment constitutes a motor together with a rotor (not shown). The motor is not particularly limited, and is, for example, a motor generator having a function as an electric motor or a generator. The motor can constitute an e-axle to constitute a drive device for an electric vehicle, together with an inverter, a gear set, and the like.

The stator 10 is a cylindrical body configured to surround a rotor disposed radially inward. The stator 10 includes a stator core 12, a refrigerant flow path 20 formed in the stator core 12, and a coil 40 wound around the stator core 12.

The stator core 12 includes a substantially annular core back 14 and a plurality of teeth 16 protruding radially inward from an inner peripheral surface of the core back 14. A slot 18, which is a space in which a part of the coil 40 is housed, is formed between the teeth 16 adjacent to each other in the circumferential direction. Since the slots 18 are provided between the teeth 16, the stator core 12 includes a plurality of slots 18.

The stator core 12 has a refrigerant flow path 20 through which a refrigerant flows through the inside of the stator core 12 in the axial direction, the refrigerant flow path 20 being provided in a portion of the stator core 12 that is at the center of the teeth 16 in the circumferential direction and close to the core back 14.

As shown in FIGS. 1 and 2, the refrigerant flow path 20 includes a refrigerant inflow port 20a that is opened to an end surface 12a of the stator core 12, which is an A end that is first end of the stator core 12, and an outflow port 20b that is opened to an end surface 12b of the stator core 12, which is a B end that is the second end of the stator core 12. The refrigerant is supplied to the inflow port 20a through a refrigerant path provided in a housing that houses the motor, and the refrigerant flows through the refrigerant flow path 20 and is discharged from the outflow port 20b. The refrigerant may be a hydrophilic fluid in addition to a hydrophobic fluid such as oil.

As shown in FIG. 2, the refrigerant flow path 20 is configured to supply the refrigerant to a section (hereinafter, simply referred to as a connection section) 80 in which a plurality of connection portions 70 of a plurality of the coils 40 in the slots 18 are disposed. Details of the refrigerant flow path 20 will be described later.

Hereinafter, a position along the axial direction in the stator core 12, the refrigerant flow path 20, and the like may be referred to as an “upstream” side closer to the inflow port 20a, and a direction closer to the outflow port 20b may be referred to as a “downstream” side.

Next, a plurality of coils 40 accommodated in each slot 18 and a plurality of first segment coils 44 and second segment coils 45 constituting the plurality of coils 40 will be described. When the plurality of coils 40, the plurality of first segment coils 44, the plurality of second segment coils 45, and the related elements are described separately, the plurality of coils 40, the plurality of first segment coils 44, the plurality of second segment coils 45, and the related elements are described with subscript alphabets, such as 40a, 44a, and 45a, respectively, and are described without distinction, the subscript alphabets are omitted. 30

The plurality of coils 40 is wound around the teeth 16 of the stator core 12. As a result, a part of the plurality of the coils 40 are housed in the slots 18 between the teeth 16. The connection mode and the winding mode of the coil 40 are appropriately selected according to the specifications of the motor. For example, the coil 40 may be configured by star connection or delta connection of coils of U phase, V phase, and W phase. The coil 40 is wound in various well-known winding modes, such as a distributed winding mode and a concentrated winding mode. The coil 40 is a coil in which a conductor 42 made of a conductive material (for example, copper) is coated with a coil film 43 made of an insulating material. The conductor 42 is a diagonal line having a substantially rectangular cross-sectional shape.

Each of the coils 40 includes, for example, a first segment coil 44 divided into two, and a second segment coil 45, which are connected by a connecting member 60 and formed into a predetermined shape. The plurality of segment coils 44, 45 are divided such that each of the segment coils 44, 45 has a length convenient for handling and can be easily connected by the connecting member 60 or the like.

The first segment coil 44 has an axial line portion that extends along the axial direction toward the B end in the slot 18. A tip end portion 48 of the axial line portion toward the B end is positioned at a substantially central portion of the slot 18 in the axial direction and faces the tip end portion 49 of the second segment coil 45. A tip end portion 48 of the first segment coil 44 is in a state where the coil film 43 is peeled off and the conductors 42 are exposed. The first segment coil 44 may be formed in a substantially U-shaped body that is provided with a pair of axial line portions and is bent and connected on the outside of the B end of the slot 18.

In addition, the second segment coil 45 has an axial line portion that extends along the axial direction toward the A end in the slot 18. A tip end portion 49 of the axial line portion toward the A end is positioned at a substantially central portion of the slot 18 in the axial direction and disposed to face the tip end portion 48 of the first segment coil 44. The tip end portion 49 of the second segment coil 45 is in a state where the coil film 43 is peeled off and the conductors 42 are exposed. The second segment coil 45 may also be formed in a substantially U-shaped body similar to the first segment coil 44.

The first segment coil 44 and the second segment coil 45 include a connection portion 70 connected by the connecting member 60. The first segment coil 44 and the second segment coil 45 are connected by the connecting member 60 to constitute a continuous coil 40 having a predetermined shape. The connecting member 60 is a substantially cylindrical body extending in the axial direction, and includes recessed portions 62, 64 in which the tip end portions 48, 49 of each of the first segment coil 44 and the second segment coil 45 are inserted into both ends and held in the connecting member 60. The connecting member 60 includes a conductor portion 66 at a central portion in a longitudinal direction of the connecting member 60. The conductor portion 66 holds the conductors 42 exposed at the tip end portions 48, 49 of the first segment coil 44 and the second segment coil 45 facing each other at the central portion of the connecting member 60 in the axial direction, and electrically connects the first segment coil 44 and the second segment coil 45.

The segment coils and the connecting members are disclosed in, for example, Japanese Unexamined Patent Application Publication No. 2019-126153 (Japanese Patent Application No. 2018-4509 (JP 2018-4509 A)).

Next, the arrangement of the connection portion 70 between the first segment coil 44 and the second segment coil 45 in the slot 18 will be described. A plurality of coils 40 is housed in the slot 18 in a predetermined form. As shown in FIG. 2, connection portions of the plurality of the coils 40 in the slot 18 are provided in a section (hereinafter, also referred to as a connection section) 80 extending over a predetermined length in the axial direction of the slot 18. In the connection section 80, the filler material F selected from known materials, such as insulating paper, for increasing the insulation of the plurality of the coils 40 is not filled. On the other hand, at least a portion adjacent to the upstream side and the downstream side of the connection section 80 is filled with the filler material F. With this, the liquid, such as the refrigerant, is inhibited from flowing between the connection section 80 and the section other than the connection section 80, and the refrigerant can be selectively allowed to flow in the connection section 80. In addition, the flow resistance of the refrigerant in the connection section 80 can be reduced to enhance the cooling effect.

In the connection section 80, the connection portions 70 of the plurality of the coils 40 are disposed such that the connection portions 70 do not adjoin each other in the radial direction and the circumferential direction. Since the connection portion 70 is easily heated, the cooling efficiency by the refrigerant can be improved by avoiding the connection portions 70 from being adjacent to each other, and thus the temperature rise of the connection section 80 can be suppressed. For example, as shown in an enlarged manner in FIG. 2, each of the connection portions 70a, 70b of the coils 40a, 40b adjacent to each other in the radial direction is disposed to be shifted in the axial direction. With this configuration, the connection portions 70a, 70b are not adjacent to each other in the radial direction. Similarly, although not shown in the drawing, each of the connection portions 70a, 70b of the coils 40a, 40b adjacent to each other in the circumferential direction is also disposed to be shifted in the axial direction, so that the connection portions 70a, 70b are not adjacent to each other in the circumferential direction.

Further, as shown in an enlarged manner in FIG. 2, in the upstream side adjacent to the connection portion 70a of the first segment coil 44a of the coil 40a, the thin diameter portion 50a having a width in a radial direction that is narrower than the other portions of the axial line portion of the first segment coil 44a over a predetermined section is provided, for example. The thin diameter portion 50a has a rectangular cross section smaller than the other portions of the axial line portion. The forming section of the thin diameter portion 50a is substantially corresponding to the length of the connection portion 70b of the adjacent other coil 40b. Similarly, on the downstream side adjacent to the connection portion 70b of the second segment coil 45b of the coil 40b, the thin diameter portion 50b having a width in the radial direction that is narrower than the other portions of the axial line portion of the second segment coil 45b over a predetermined section is provided, for example. The forming section of the thin diameter portion 50b is substantially corresponding to the length of the connection portion 70a of the adjacent other coil 40a. In this way, the flow resistance of the refrigerant in the connection section 80 can be reduced to enhance the cooling effect.

As shown in FIGS. 3A and 3B, in the connection section 80, the teeth 16 may be formed to be thin at least partially such that the wall portion 17a facing the coil 40 of the teeth 16 defining the slot 18 is spaced apart from the coil 40 more than the other sections of the slot 18 in which the connection section 80 is not defined. In this way, by separating the refrigerant, the flow resistance of the refrigerant in the connection section 80 can be reduced, and the cooling effect can be enhanced. Further, the wall portion 17b facing the coil 40 at the radially inner end of the teeth 16 may be formed to be thin so as to be separated from the coil 40. In this way, by separating the refrigerant, the flow resistance of the refrigerant can be reduced, and the cooling effect can be enhanced.

The stator core 12 is, for example, a laminated steel plate in which a plurality of electromagnetic steel plates is laminated in a thickness direction. For example, the magnetic powder core is a core formed by press-molding the insulating-coated magnetic particles.

Next, the refrigerant flow path 20 that supplies the refrigerant to the connection section 80 will be described in detail. As shown in FIG. 2, the refrigerant flow path 20 includes a first flow path 22 that extends from the inflow port 20a to a position corresponding to the upstream end of the connection section 80 along the axial direction in the central portion of the tooth 16 in the circumferential direction. The refrigerant flow path 20 includes a second flow path 23 that extends along the axial direction to reach the outflow port 20b at a position corresponding to the downstream end of the connection section 80. The inflow port 20a, the first flow path 22, the second flow path 23, and the outflow port 20b are on the same axis along the axial direction. The first flow path 22 and the second flow path are examples of a first axial refrigerant flow path and a second axial refrigerant flow path disclosed in the present specification.

As shown in FIG. 2 and FIGS. 3A and 3B, the refrigerant flow path 20 further includes a first communication flow path 24 that extends from the downstream end of the first flow path 22 toward a connection section 80 of the slot 18 that is adjacent to the first flow path 22 in the circumferential direction (right side in FIGS. 3A and 3B). The first communication flow path 24 reaches the upstream end of the connection section 80 along the circumferential direction. The first communication flow path 24 supplies the refrigerant from the first flow path 22 to the connection section 80. The first communication flow path 24 is an example of the first communication refrigerant flow path disclosed in the present specification.

Further, as shown in FIG. 2 and FIGS. 3A and 3B, the refrigerant flow path 20 includes a second communication flow path 25 that extends from the downstream end of the connection section 80 toward the second flow path 23. The second communication flow path 25 reaches the second flow path 23 along the circumferential direction. The second communication flow path 25 allows the refrigerant that has flowed through the connection section 80 to flow out from the outflow port 20b through the second flow path 23. The second communication flow path 25 is an example of the second communication refrigerant flow path disclosed in the present specification.

Further, as shown in FIG. 2 and FIGS. 3A and 3B, the refrigerant flow path 20 does not have a refrigerant flow path along the axial direction in the section of the stator core 12 corresponding to the connection section 80. Therefore, all the refrigerant passing through the first flow path 22 is supplied to the connection section 80, and then flows out through the second flow path 23.

Next, the cooling effect of the stator 10 and the coil 40 in the stator 10 will be described. As shown in FIG. 2, when the refrigerant is supplied to the inflow port 20a, the refrigerant flows through the first flow path 22, the first communication flow path 24, the connection section 80, the second communication flow path 25, and the second flow path 23, and is discharged from the outflow port 20b. As a result, the stator core 12 and the coil 40 are cooled. In particular, the supply is also made to the connection section 80 where the connection portions 70 of the first segment coil 44 and the second segment coil 45 are disposed. As a result, the connection portion that is easily rise in temperature can be effectively cooled, and as a result, the coil 40 can be effectively cooled.

In the connection section 80, the insulating filler material F is not provided between the coils 40, and thus the flowability of the refrigerant can be enhanced, and the connection portion 70 can be effectively cooled.

In the connection section 80, the connection portions 70 of the adjacent coils 40 are disposed not to be adjacent in the circumferential direction and the radial direction, so that the flowability of the refrigerant and the cooling effect can be enhanced. In addition, the connection portion 70 of one coil 40 adjacent to each other is adjacent to the thin diameter portion 50 of the other coil 40, so that the flowability of the refrigerant is enhanced, and the connection portion 70 can be effectively cooled.

### Second Embodiment

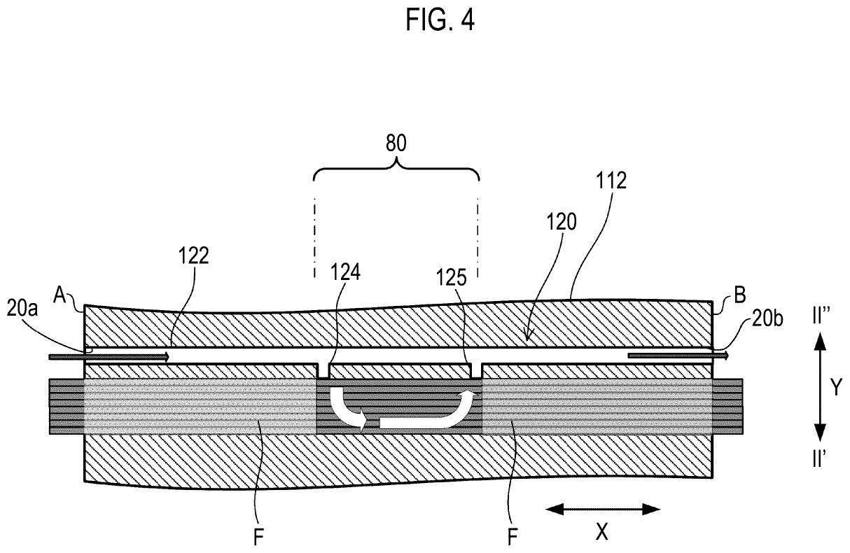

FIG. 4 relates to a second embodiment. FIG. 4 shows a cross-sectional structure of the stator core 112 of the second embodiment. FIG. 4 corresponds to a cross section of the II-II line in FIG. 1. The same reference numerals are used to describe the same elements as those in the first embodiment.

As shown in FIG. 4, the stator core 112 of the present embodiment has the same configuration as the first embodiment, except that the stator core 112 includes the refrigerant flow path 120 having a flow path configuration different from the refrigerant flow path 20 of the first embodiment.

The refrigerant flow path 120 includes a first flow path 122 that communicates from the inflow port 20a to the outflow port 20b in a central portion of the teeth 16 in the circumferential direction. The refrigerant flow path 120 further includes a first communication flow path 124. The first communication flow path 124 extends along the circumferential direction toward the upstream end (an example of the first intermediate position disclosed in the present specification) of the connection section 80 in the slot 18 adjacent to the first flow path 122 in the circumferential direction (corresponding to the right side in FIG. 4) in the central portion of the stator core 12 in the axial direction. The first communication flow path 124 supplies the solvent from the first flow path 122 to the connection section 80. The first flow path 122 is an example of an axial refrigerant flow path disclosed in the present specification, and the first communication flow path 124 is an example of a first communication refrigerant flow path disclosed in the present specification.

Further, the refrigerant flow path 120 includes a second communication flow path 125. The second communication flow path 125 extends along the circumferential direction from a position of the first flow path 122 corresponding to the downstream end of the connection section 80 (an example of the second intermediate position disclosed in the present specification) toward the downstream end of the connection section 80. The second communication flow path allows the refrigerant that has flowed through the connection section 80 to flow out to the first flow path 122. The first communication flow path 124 and the second communication flow path 125 are examples of the second communication refrigerant flow path disclosed in the present specification.

According to the second embodiment, in a case where the refrigerant is supplied to the inflow port 20a, the refrigerant flows through the first flow path 122, the first communication flow path 124, the second communication flow path 125, and the first flow path 122, and is discharged from the outflow port 20b. As a result, the stator core 12 and the coil 40 are cooled in the same manner as in the first embodiment. Further, as in the first embodiment, the connection portion 70 of the segment coil that is easily rise in temperature can be effectively cooled, and as a result, the coil 40 can be effectively cooled. According to the second embodiment, since the refrigerant flow path 120 is provided to penetrate the entire axial direction of the stator core 12 along the axial direction, the refrigerant flow path configuration is simple, and a refrigerant having a high cooling effect that does not pass through the connection section 80 can be supplied downstream of the connection section 80.

### Third Embodiment

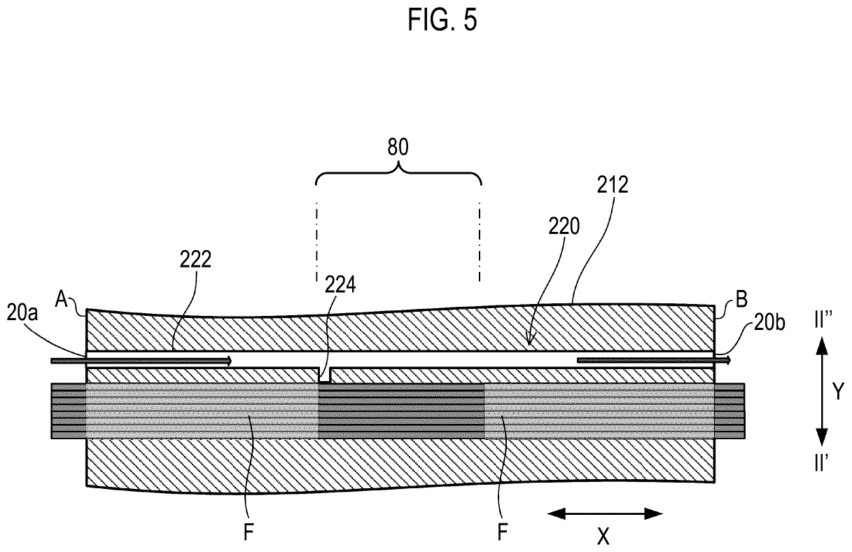

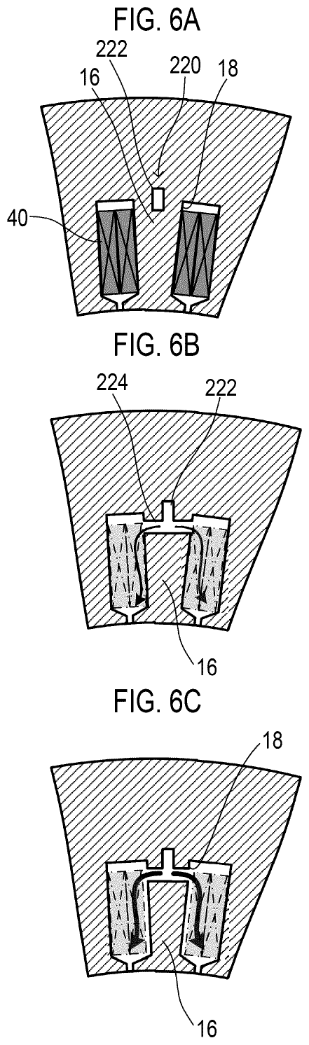

FIG. 5 and FIGS. 6A, 6B, and 6C relate to a third embodiment. FIG. 5 shows a cross section of the stator core 112 of the third embodiment taken along the line II-II in FIG. 1 showing the cross-section structure of the stator core 112, and FIGS. 6A to 6C show the A-A line cross section, the B-B line cross section, and the C-C line cross section of FIG. 5, respectively. The same reference numerals are used to describe the same elements as those in the first embodiment.

As shown in FIG. 5, the stator core 212 of the present embodiment has the same configuration as the first embodiment except that the stator core 212 includes the refrigerant flow path 220 having a flow path configuration different from the refrigerant flow path 20 of the first embodiment and the tooth width defining the connection section 80 of the slot 18 is narrow.

As shown in FIG. 5, the refrigerant flow path 220 includes a first flow path 222 that communicates from the inflow port 20a to the outflow port 20b in a central portion of the tooth 16 in the circumferential direction. The refrigerant flow path 220 further includes a first communication flow path 224.

As shown in FIG. 5 and FIGS. 6A and 6B, the first communication flow path 224 extends along the circumferential direction toward the upstream end of the connection section 80 in both of the slots 18 adjacent to the first flow path 222 in the circumferential direction (right and left sides in FIGS. 6A, 6B, and 6C) in the central portion of the stator core 12 in the axial direction. The first communication flow path 224 supplies the refrigerant to the connection section 80. The first flow path 222 is an example of an axial refrigerant flow path disclosed in the present specification, and the first communication flow path is an example of a communication refrigerant flow path disclosed in the present specification.

As shown in FIG. 6C, in the connection section 80, the width of the teeth 16 is formed to be narrower than that of the first embodiment. As a result, the width (the width of the slot 18) along the circumferential direction of the connection section 80 is increased. In addition, as the width of the teeth 16 is reduced, the width (opening width of the slot 18) between the teeth 16 facing each other on the radially inner side of the slot 18 is increased.

According to the third embodiment, in a case where the refrigerant is supplied to the inflow port 20a, the refrigerant flows through the first flow path 222 and is discharged from the outflow port 20b. As a result, the stator core 12 is cooled. The refrigerant is supplied to the connection section 80 through the first communication flow path 224 and flows out radially inward. As a result, the connection portion 70 of the segment coil that is easily increased in temperature can be effectively cooled, and as a result, the coil 40 can be effectively cooled.

According to the third embodiment, since the refrigerant flow path 220 is provided to penetrate the entire axial direction of the stator core 12 along the axial direction, the refrigerant flow path configuration is simple, and a refrigerant having a high cooling effect that does not pass through the connection section 80 can be supplied downstream of the connection section 80. In addition, according to the third embodiment, since solely the first communication flow path 224 is provided, the flow path configuration can be simplified. Further, according to the third embodiment, since the width of the teeth 16 formed narrower, as a result, the width of the slot 18 and the opening width of the slot 18 on the radially inner side are widened. Therefore, the refrigerant supplied to the connection section 80 has enhanced flowability toward the radially inner side of the slot 18, and the cooling effect can be enhanced.

In the above-described embodiments, the coil 40 is configured by the first segment coil 44 and the second segment coil 45, but the present disclosure is not limited thereto, and the coil 40 may be configured by three or more segment coils.

In addition, in the above-described embodiments, one connection section 80 is provided in the slot 18, but a plurality of connection sections 80 may be appropriately provided depending on the manner of division of the segment coils of the coil 40.

In addition, in the above-described embodiments, the first segment coil 44 and the second segment coil 45 are provided with the thin diameter portion 50 so as to be adjacent to the connection portion of the other adjacent segment coil, but the thin diameter portion 50 does not have to be provided. Further, although the connection portions 70 of the adjacent coils 40 are disposed not to overlap in the circumferential direction and/or the radial direction, the present disclosure is not limited thereto, and at least a part of the connection portions 70 may overlap depending on the flowability of the refrigerant in the connection section 80.

In addition, in the first and second embodiments, the width of the teeth 16 is narrowed and the width of the slot 18 and the opening width of the slot 18 on the radially inner side are widened, but the width of the teeth 16 and the width of the slot 18 and the opening width of the slot 18 on the radially inner side can be appropriately changed in view of the flowability and the cooling performance of the refrigerant.

Although specific examples of the technique disclosed in the present specification have been described in detail above, these examples are merely illustrative and do not limit the scope of the claims. The techniques described in the claims include various modifications and changes of the specific examples exemplified above. The technical elements described in the present specification or the drawings exhibit technical usefulness alone or in various combinations, and are not limited to the combinations described in the claims at the time of filing. The technique exemplified in the present specification or the drawings can achieve a plurality of purposes at the same time, and achieving one of the purposes itself has technical usefulness.

What is claimed is:

1. A stator comprising:
a stator core including a slot extending in an axial direction;
at least one first segment coil extending in the slot of the stator core in a first direction;
at least one second segment coil extending in the slot of the stator core in a second direction;
at least one connecting member that connects a tip end of the at least one first segment coil to a tip end of the at least one second segment coil in the slot of the stator core; and
a refrigerant flow path that passes through an inside of the stator core, wherein the refrigerant flow path is connected to a part of a section of the slot, the section being a section in which the at least one connecting member is positioned.

2. The stator according to claim 1, wherein the refrigerant flow path includes:
a first axial refrigerant flow path extending from a first end of the stator core along the axial direction;
a second axial refrigerant flow path extending from a second end of the stator core along the axial direction;
a first communication refrigerant flow path extending from the first axial refrigerant flow path to the section of the slot; and
a second communication refrigerant flow path extending from the second axial refrigerant flow path to the section of the slot.

3. The stator according to claim 1, wherein the refrigerant flow path includes:
an axial refrigerant flow path extending from a first end of the stator core to a second end of the stator core along the axial direction;
a first communication refrigerant flow path extending from a first intermediate position of the axial refrigerant flow path to the section of the slot; and
a second communication refrigerant flow path extending from a second intermediate position different from the first intermediate position of the axial refrigerant flow path to the section of the slot.

4. The stator according to claim 1, wherein the refrigerant flow path includes:
an axial refrigerant flow path extending from a first end of the stator core to a second end of the stator core along the axial direction; and
a communication refrigerant flow path extending from an intermediate position of the axial refrigerant flow path to the section of the slot.

5. The stator according to claim 1, wherein both sides of the section in the axial direction are filled with a filler material inside the slot.

6. The stator according to claim 5, wherein the connecting member is disposed to be shifted in the axial direction of the stator core from a connecting member of another segment coil of the stator core that is adjacent in a radial direction or a circumferential direction.
